(19) United States
(12) Patent Application Publication
(10) Pub. No.: US 2003/0084759 A1
(43) Pub. Date: May 8, 2003

(54) Precision screwdriver

(75) Inventor: Enrico Carini, Castelfidardo (IT)

Correspondence Address: ARMSTRONG, WESTERMAN & HATTORI, LLP, Suite 220, 502 Washington Avenue, Towson, MD, 21204, US

(73) Assignee: PIERGIACOMI SUD - S.R.L.

(21) Appl. No.: 10/287,131

(22) Filed: Nov. 1, 2002

(30) Foreign Application Priority Data
Nov. 5, 2001 (IT) MC2001A000105

(51) Int. Cl. B25G 1/00

(52) U.S. Cl. 81/492

(57) ABSTRACT

The present invention relates to a precision screwdriver comprising a handle and a cylindrical cap that idles on the top of the handle (2), which ends with a pin (2a). The cap and pin are moulded with hard plastics and have anti-friction smooth coupling surface. The pin is moulded from a single piece with the handle body, which is entirely covered by an anti-slip soft plastics moulded sheath.

The present patent application relates to a precision screwdriver, of the type comprising a handle that ends with a cap that rotates on top of the handle (2), designed to act as support for the index finger tip.

In standard operation conditions the handle is held between the thumb and middle finger tips to provide the rotation torque, while the tip of the of the index finger is pressed on top of the handle to provide the axial thrust and guarantee a firm hold of the screwdriver tip inside the screw head.

In order to provide stable support and thrust surface for the index finger, the top of the handle is usually equipped with a cap that idles around a pin that axially protrudes from the top of the handle, so that the cap can remain still during the rotation of the handle held between thumb and middle finger.

Based on this standard construction, each manufacturer has proposed different versions, especially when the handle is moulded with plastics or rubber.

In the latter case, two opposite requirements must be met: the first requirement refers to the need to provide an anti-slip surface for the fingers, while the second requirement refers to the need to prevent any possible adhesion between cap and handle.

The first need requires the use of soft moulding materials with rough finish, to provide firm and safe hold for precision works. On the other side, the second requirement requires the use of hard moulding materials with smooth surface to eliminate any possible friction between handle and cap.

The European patent EP 0508849 discloses a precision screwdriver that comprises two elements, that is a handle and a cap that idles on top of the handle, being both elements characterised by suitable shape and dimensions to provide easier and safer grip when the user holds the screwdriver.

The patent PCT/SI/00/00007 discloses a precision screwdriver that comprises a handle and a rotating cap of anti-slip soft material. The screwdriver is characterised in that the cap is inserted on an anti-friction collar, which is in turn inserted on a pin that protrudes from the hard plastics handle head. This model of screwdriver is composed of three elements, that is handle, cap and anti-friction collar.

The purpose of the present invention is to realise a precision screwdriver with handle with anti-slip surface and anti-friction head, in order to provide total grip for the fingers that hold the handle and total rotation of the cap that is joined to the head.

The screwdriver of the invention comprises a handle and a rotating cap of moulded hard anti-friction plastics in order to prevent any possible adhesion between the two elements.

The cap handle is covered with a thin sheath of soft material in order to provide safe grip. The sheath is provided with a series of holes, through which the body of the moulded hard anti-friction plastics handle can be seen.

In a preferred embodiment of the invention, the hard smooth surface of the handle remains on the bottom of the slots, whose edges act as grip points for the finger tips used to give the rotation torque to the screwdriver handle.

In an alternative embodiment of the invention, suitable protuberances made of the same material and obtained during moulding slightly protrude from the slots, in order to favour the constant gradual application of the rotation torque on the handle.

For major clarity the description of the screwdriver of the invention continues with reference to the enclosed drawings, which are intended for purposes of illustration and not in a limiting sense, whereby:

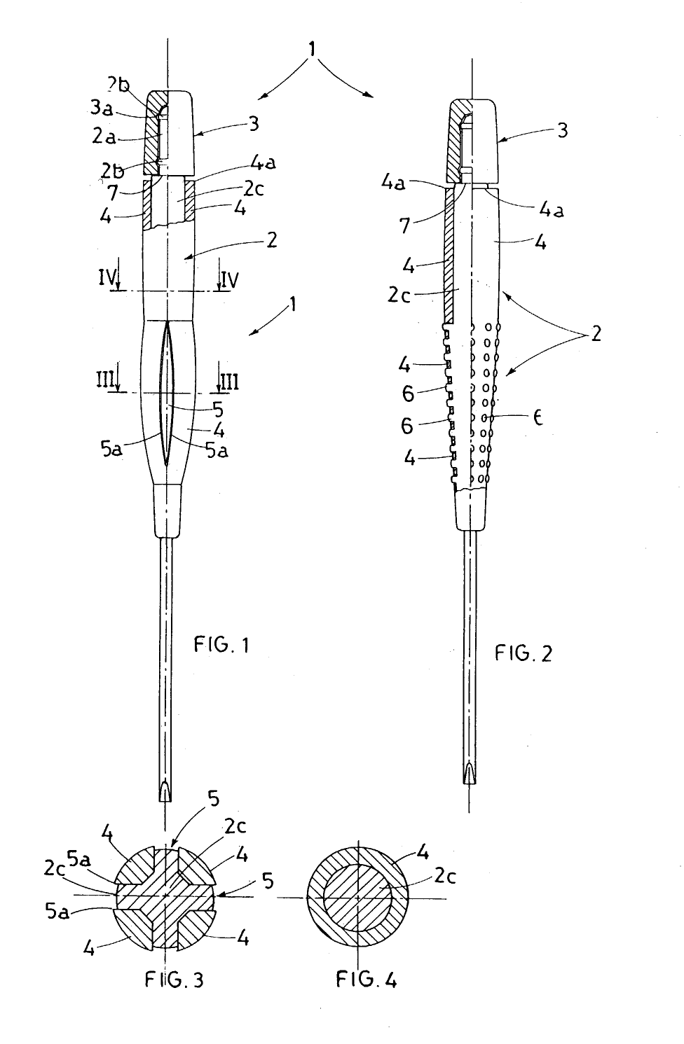

FIG. 1 is a diagrammatic view of the screwdriver of the invention in a first preferred embodiment, with cross-section of some parts to show the internal elements;

FIG. 2 is a diagrammatic view of the screwdriver of the invention in an alternative embodiment, half in plan view and half in cross-section;

FIG. 3 is the cross-section of FIG. 1 with plane III-III;

FIG. 4 is the cross-section of FIG. 1 with plane IV-IV.

With reference to the figures, the screwdriver (1) of the invention comprises a handle (2) and a cylindrical cap (3) that rotates on top of the handle (2) ending with a pin (2a) on which the cap (3) is inserted and fixed.

More precisely, the pin (2a) has two annular ribs (2b) designed to be fitted into suitable annular grooves (3a) located on the inside of the cap (3), which, although free to idle around the pin (2a), cannot disengage from the pin because of the annular ribs (2b).

To provide the cap (3) with maximum rotation with respect to the handle (2), the pin (2a) and the cap (3) are moulded with hard plastics and have smooth anti-friction coupling surface.

It must be said that the pin (2a) is moulded from a single piece with the body (2c) of the handle, which is completely covered, except for the ending pin (2a), by a anti-slip soft moulded sheath (4) provided with a series of slots through which the body of the anti-friction hard plastics moulded handle can be seen.

In the constructive version of FIG. 1 the sheath (4) has longitudinal elongated slots (5); the hard smooth surface of the body (2c) remains on the bottom of the slots, whose edges (5a) can act as grip points for the finger tips used to give the rotation torque to the handle (2) of the screwdriver (1).

In the constructive of FIG. 2, the sheath (4) has a series of small circular slots from which suitable protuberances (6) moulded with the same material of the body (2c) of the handle (2) slightly protrude.

It must be said that the sheath (4) ends before it reaches the shoulder (7) against which the cap (3) touches, in such a way that no friction exists between the cap and the ending edge (4a) of the sheath (4).

Finally, it must be noted that the slots (5) and protuberances (6) are only located on half of the handle near the screwdriver stem.

1. Precision screwdriver of the type comprising a handle (2) and a cylindrical cap (3) that idles on top of the handle (2), which ends with a pin (2a) on which the cap (3) is inserted and fixed, characterised in that the pin (2a) and the cap (3) are moulded with hard plastics and have anti-friction smooth coupling surface and the pin (2a) is moulded from a single piece with the body (2c) of the handle, which is entirely covered, except for the ending pin (2a), with an anti-slip soft plastics moulded sheath (4) provided with a series of slots through which the anti-friction hard plastics moulded body (2c) can be seen, being provided that the sheath (4) ends before reaching the shoulder (7) against which the cap (3) touches.

2. Screwdriver according to the preceding claim, characterised in that the sheath (4) has longitudinal elongated slots (5) through which the internal body (2c) can be seen, whose smooth hard surface remains on the bottom of the slots (5), whose edges (5a) act as grip points for the finger tips.

3. Screwdriver according to claim 1), characterised in that the sheath (4) has a series of small circular slots from which suitable protuberances (6) moulded with the same material of the body (2c) of the handle (2) slightly protrude.

4. Screwdriver according to the preceding claims, characterised in that the slots (5) and protuberances (6) are only located on half of handle near the screwdriver stem.
